(19) United States
(12) Patent Application Publication
(10) Pub. No.: US 2014/0279703 A1
(43) Pub. Date: Sep. 18, 2014

(54) Systems and methods for parameter estimation for use in determining value-at-risk

(71) Applicant: Open Access Technology International, Inc., Minneapolis, MN (US)

(72) Inventors: Guillermo Irisarri, Plymouth, MN (US); Sasan Mokhtari, Eden Prairie, MN (US); Ilya William Slutsker, Plymouth, MN (US)

(73) Assignee: Open Access Technology International, Inc., Minneapolis, MN (US)

(21) Appl. No.: 14/216,209

(22) Filed: Mar. 17, 2014

Related U.S. Application Data
(60) Provisional application No. 61/791,727, filed on Mar. 15, 2013.

(51) Int. Cl. G06Q 40/06

(52) U.S. Cl. CPC G06Q 40/06
USPC 705/36 R

(57) ABSTRACT

A process is provided, that facilitates the use of value-at-risk analysis in industries with dynamic market data. The method utilizes past market data to estimate future market parameters. The method includes identifying and removing seasonal patterns from said past market data and normalizing deseasonalized market data with a repeated method of replacing large outliers with mean values. Outliers and normalized data are then grouped separately. Forecasts of normalized future market data and forecasts of future outlier patterns are then determined from said separate groups. In this way parameters used for value-at-risk analysis can be accurately estimated, leading to precise value-at-risk-analysis results.

### CROSS-REFERENCE TO RELATED APPLICATIONS

This application claims priority to U.S. Provisional patent application No. 61/791,727 filed Mar. 15, 2013, the entire content of which is hereby incorporated by reference.

Applicant has other co-pending applications directed to the energy market, namely:

SYSTEMS AND METHODS FOR DEMAND RESPONSE AND DISTRIBUTED ENERGY RESOURCE MANAGEMENT, filed Feb. 9, 2011 and assigned application Ser. No. 13/024,158, the entire contents of which is hereby incorporated by reference.

AUTOMATION OF ENERGY TRADING, filed Dec. 30, 2011 and assigned application Ser. No. 13/140,248, the entire contents of which is hereby incorporated by reference.

CERTIFICATE INSTALLATION AND DELIVERY PROCESS, FOUR FACTOR AUTHENTICATION, AND APPLICATIONS UTILIZING SAME, filed Oct. 15, 2013 and assigned application Ser. No. 14/054,611, the entire contents of which is hereby incorporated by reference.

A renewable energy credit management system and method, filed Feb. 10, 2014 and assigned application Ser. No. 14/176,590, the entire contents of which is hereby incorporated by reference.

Systems and methods of determining optimal scheduling and dispatch of power resources, filed on Mar. 17, 2014 (Docket No. O17.2P-15315-US03), the entire contents of which is hereby incorporated by reference.

Systems and methods for managing energy generation and procurement, filed on Mar. 17, 2014 (Docket No. O17.2P-15469-US03), the entire contents of which is hereby incorporated by reference.

Systems and methods for tracing electrical energy of a load to a specific generator on a power grid, filed on Mar. 17, 2014 (Docket No. O17.2P-15493-US03), the entire contents of which is hereby incorporated by reference.

Systems and methods for trading electrical power, filed on Mar. 17, 2014 (Docket No. O17.2P-15565-US03), the entire contents of which is hereby incorporated by reference.

Systems and methods for managing conditional curtailment options, filed on Mar. 17, 2014 (Docket No. O17.2P-15571-US03), the entire contents of which is hereby incorporated by reference.

Systems and methods for tracking greenhouse gas emissions, filed on Mar. 17, 2014 (Docket No. O17.2P-15954-US02), the entire contents of which is hereby incorporated by reference.

Systems and methods for managing transmission service reservations, filed on Mar. 17, 2014 (Docket No. O17.2P-15956-US02), the entire contents of which is hereby incorporated by reference.

Systems and methods for interfacing an electrical energy end user with a utility, filed on Mar. 17, 2014 (Docket No. O17.2P-15958-US02), the entire contents of which is hereby incorporated by reference.

Use of Demand Response (DR) and Distributed Energy Resources (DER) to mitigate the impact of Variable Energy Resources (VER) in Power System Operation, filed on Mar. 17, 2014 (Docket No. O17.2P-15959-US02), the entire contents of which is hereby incorporated by reference.

### STATEMENT REGARDING FEDERALLY SPONSORED RESEARCH

Not Applicable

### FIELD OF THE INVENTION

The present disclosure relates generally to analyzing the risk associated with commodity trading and, more particularly, to systems and methods of estimating parameters for use in calculating value-at-risk analysis of commodity portfolios.

### BACKGROUND OF THE INVENTION

In general, this disclosure is directed toward systems and methods of estimating various market parameters required for determining value-at-risk. Value-at-risk analysis can be determined using several methodologies, including but not limited to the Monte Carlo method, the Analytical method, the Historical method, and others. Each method requires a set of historical market data along with certain parameters in order to perform calculations to arrive at estimated values for volatilities, correlations, and other such metrics known in the art. Frequently required parameters include equilibrium-price volatility, correlation of spot price and equilibrium price, speed of mean reversion, long-term equilibrium price, equilibrium-price growth rate, jump rate, jump volatility, mean jump size, among others. The process under current use in the art for setting parameter values is analogous to randomly picking values from within a specified range. In rare cases in which parameters are available from the market in some form, parameter validation can be difficult and time consuming, if even possible. Moreover, markets that provide parameters do not do so consistently. Manually entering assumed variable values can lead to wide ranges of results for determining risk and is subject to human error. Therefore, any methodology for calculating risk that depends on such assumed variables, such as the Monte Carlo method for determining value-at-risk, have not been able to provide as reliable results as are often desired.

Moreover, some commodities, including but not limited to electricity, gas, and grain, experience a seasonal influence, i.e. electricity demand is highest in the peak consumption months of summer and winter as compared to the spring and fall. Often times, systems and methods calculating value-at-risk do not account for seasonality or the impacts of seasonality on parameter estimation values, therefore increasing additional error into value-at-risk analysis that is dependent on such parameter estimations for accurate metrics.

In addition, this section should not be construed to mean that a search has been made or that no other pertinent information as defined in 37 C.F.R. §1.56(a) exists.

### BRIEF SUMMARY OF THE INVENTION

In order to solve the problems discussed above, applicants have developed a system and method that, in a preferred embodiment, is directed toward a computer program comprising a computer-usable medium having computer-readable program code means embodied in the medium for calculating and estimating various financial-modeling parameters and other values. Said computer program is able to arrive at previously unattained levels of accuracy in parameter estimation by incorporating historical market data and taking account of seasonality impacts and other irregularities. Estimated parameters can then be used in value-at-risk analysis to provide a far clearer picture of future risk than was possible prior to the development described in the current disclosure.

The invention is capable of incorporating market data of multiple different types from multiple sources, including direct user input. Multiple types of patterns in said data are identified through several levels of data-smoothing methods. The resulting smoothed data and removed pattern information are both used by the computer program to accurately estimate parameters used to predict future patterns used for value-at-risk analysis. The invention may store the estimated parameter values for future use, display the parameter values to a user, or automatically send the parameter values to a value-at-risk calculation engine.

### BRIEF DESCRIPTION OF DRAWINGS

FIG. 1 is a block diagram illustrating a method of using the parameter calculation-estimation module utilizing a user interface.

FIG. 2 is a block diagram illustrating one embodiment of the parameter calculation-estimation process.

FIG. 3 is a block diagram illustrating a computer system that may be utilized in the performance of the disclosed methods and processes.

### DETAILED DESCRIPTION OF THE INVENTION

It will be seen that FIG. 1 is a block diagram illustrating one embodiment of a user-directed method of using the parameter calculation-estimation module to produce a list of Estimated Parameter Values 112 for use in a value-at-risk determination. Upon user's direction, Historical Market Data 104 is loaded into Database 106 in Module 100. Historical Market Data 104 could be derived from user's own records, collected from available market-information sources by the module, or provided by a third party such as a data broker. Regardless of the source, Historical Market Data 104 should provide information on patterns of the market in question, such as a history of prices. Users may augment Historical Market Data 104 in Database 106 by Manual User Entry 110. Examples of such augmentation may include a user editing the market's pricing history, or adding to said pricing history with user's projections of future pricing. Database 106 then transfers Historical Market Data 104 and augmented data from Manual User Entry 110 to the Parameter Estimation Calculation Engine 108. While Database 106 and Parameter Estimation Calculation Engine 108 are here represented as both integral to Module 100, in some embodiments they may be portions of two different modules. For example, some embodiments may store all data in a large database not solely dedicated to this module, in which cases Database 106 and Parameter Estimation Calculation Engine 108 may be separately located.

Upon receiving the necessary data, Parameter Estimation Calculation Engine 108 performs the necessary steps to extrapolate/interpolate and estimate all Estimated Parameter Values 112 for use in value-at-risk analysis. An embodiment of these steps will be disclosed in the discussion concerning FIG. 2. Parameter Estimation Calculation Engine 108 writes said Estimated Parameter Values 108 to Database 106. At this point user may view Estimated Parameter Values 112 by querying the Module 100, or Database 106 in embodiments in which the two are distinctly controlled. Database 106 then sends Estimated Parameter Values 112 to User Interface 102 for viewing. User Interface 102 may exist as a computer program run in a computer operated by a user. In further embodiments, Parameter Estimation Calculation Engine 108 may concurrently send Estimated Parameter Values 112 to User Interface 102 and Database 106, and/or may send Estimated Parameter Values 112 to a database under the user's control that is distinct from Database 106.

While these embodiments are presented as controlled by user action, it is also possible for all steps to be performed in the absence of user involvement. For example, user's system may be programmed to perform all steps automatically when user's projections of future pricing are updated, or may run periodically with updated market data purchased at set intervals. In said embodiments, Parameter Estimation Calculation Engine 108 or Database 106 may write Estimated Parameter Values 112 to user's database in the form of a log, or may send Estimated Parameter Values 112 to user in a message format, such as email.

FIG. 2 illustrates one embodiment of steps through which an engine such as Parameter Estimation Calculation Engine 108 in FIG. 1 could run to develop parameters necessary for value-at-risk analysis. In this embodiment, historical market data is transferred to, and processing occurs in, Estimation Engine 200. Estimation Engine 200 first Extrapolates Seasonality Curve 202, said seasonality curve being an approximated pattern of any observed periodic fluctuations in the data. For example, the market for winter clothing would likely exhibit periodic fluctuations with a period of one year, whereas the market for alcoholic beverages would exhibit periodic fluctuations with a period of one week, and the residential market for water would exhibit periodic fluctuations with a period of one day. In preferred embodiments said seasonality curve reflects all said periodic fluctuations that are applicable to a market. In this embodiment said seasonality curve is representable as a mathematical equation, such as a sinusoidal equation or a step function for less precise approximations. The seasonality of the residential market for water over a period of one week, for example, may be expressed by a sinusoidal equation wherein the local maxima of the resulting curve would occur both in the morning and at night, during which residents are showering to prepare for work and running water to prepare meals respectively. Local minima would occur during the day, while residents are not at home. Non-local maxima would occur on days that the most residents do not work, and thus are more likely to use more water throughout the day, and may be more active at night. While in this embodiment Estimation Engine 200 determines seasonality patterns by an extrapolation process, it is equally possible to determine seasonality patterns by an interpolation process.

After having Extrapolated Seasonality Curve 202, Estimation Engine 200 Removes Seasonality Effects 204 by subtracting from all points of market data the corresponding value on the seasonality curve. For example, if said market data were spot prices of crude oil every day over a period of two years, Estimation Engine 200 would subtract the price value of the seasonality curve for each day from the spot price of the corresponding day in the original market data. This would result in a set of deseasonalized data.

Most sets of market data will exhibit other fluctuations in addition to periodic seasonality fluctuations, and thus said deseasonalized data cannot be accurately used in value-at-risk estimations. Fluctuations in deseasonalized data are usually exhibited in the form of temporary sharp increases in the market value (outliers in price or demand, for example) at multiple times throughout the longer period. Estimation Engine 200 locates and removes these outliers with a repeated process of Identifying Jump Values 206, Removing Jump Values 208, and Recalculating Jump Threshold 212. Identifying Jump Values 206 operates by identifying values (“jump values”) outside a jump threshold. The jump threshold takes the form of the standard deviation of the market data with a positive multiplier attached. Said multiplier is a value set by the user or set in the code and will generally fall between 3 and 5, but could be any positive number. Thus, if said multiplier were set at 4, Estimation Engine 200 would identify all values outside of 4 standard deviations in the market data as a jump value 206, and remove those jump values from the deseasonalized data 208, replacing them with the mean value so the process of identifying additional jumps may continue. Estimation Engine 200 Records Removed Jump Values 210 concurrently with Removing Jump Values 208. Estimation Engine 200 may Record Removed Jump Values 210 on a storage medium internal to the module or an external storage medium. Estimation Engine 200 then Recalculates Jump Threshold 212 using the new set of market data from which the jump values were removed. The new jump threshold will thus take the form of the standard deviation of said new set of market data with the same positive multiplier attached. Estimation Engine 200 then performs the Identification of Jump Values 206 again, this time with said new set of market data. If more jump values are identified, they are removed and recorded in Remove Jump Values 208 and Record Removed Jump Values 210 respectively. This cycle is repeated until the new standard deviation is not materially different than the prior standard deviation. The threshold for this standard deviation difference could theoretically be any number, but is preferably a very small quantity, such as a 0.001% difference. The remaining data, after all jumps are removed, are the normal, non-seasonal data, and are collectively referred to, in this embodiment, as the Equilibrium Data 214.

After the data is deseasonalized and jump values have been removed two sets of modified market data are available: the removed jump values and the Equilibrium Data 214. The engine is able to estimate the additional parameters needed for value-at-risk analysis from these two sets of data. If market data are historical prices, at least eight additional estimated parameters will be necessary in most value-at-risk analyses: (1) long-term equilibrium price, (2) equilibrium price growth rate, (3) equilibrium price volatility, (4) rate of mean reversion, (5) correlation of equilibrium price and spot price, (6) “jump” rate, (7) “jump” volatility, and (8) mean “jump” size. While some analyses may use fewer parameters, and some may use more parameters, an understanding of these eight parameters should enable the estimation of all parameters necessary for any value-at-risk analysis.

The Equilibrium Data 214 can be used to estimate the equilibrium-price parameters. In almost all data sets there will still be some noise diverting from the mean that cannot be explained. Therefore, the long-term equilibrium price is estimated to be the mean of the equilibrium-price data. Said mean can be found by performing a linear regression of the equilibrium-price data. The slope of said linear regression is the estimated equilibrium-price growth rate. Equilibrium-price volatility is estimated to be the average magnitude of noise divergences from the mean. Rate of mean reversion is the rate at which the price returns to the long-term equilibrium price from a noise divergence. Correlation of equilibrium price and spot price can be estimated by comparing particular values of spot price and equilibrium prices or comparing the means of each.

The removed jump values can be used to represent the jump parameters. Jump parameters can be estimated by performing a linear regression of the jump values. Jump rate is estimated as the average time between past jumps. Jump volatility is estimated as the amount of variance in the size of jumps. Mean jump size is the average size of all jumps.

Some or all of the previously discussed embodiments may be performed utilizing a computer or computer system. An example of such a computer or computer system is illustrated in FIG. 3. Computer 300 contains Central Processing Unit 302. Central Processing Unit 302 may perform some or all of the processes involved in the previously discussed embodiments. Central Processing Unit 302 may utilize information contained in Memory 304, Database 306, or both. Central Processing Unit 302 may also write information to Memory 304, Database 306, or both. While in this FIG. 3 only one Computer 300 is shown, some embodiments may make use of multiple computers or computer systems. In some embodiments some of these computers or computer systems may not have dedicated memory or databases, and may utilize memory or databases that are external to the computer or computer system.

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

1. A system for parameter estimation for use in determining value-at-risk, comprising:
a computer program for use with a computer having a memory;
a database of historical market data;
the computer program configured to:
process the historical market data to remove seasonality effects;
process the historical market data to identify and remove jump values;
save the removed jump values as a first set of modified market data;
save the historical market data that have been processed to remove seasonality and jump values as a second set of modified market data;
use the first and second set of modified market data to estimate one or more of the parameters selected from the group consisting of long-term equilibrium price, equilibrium price growth rate, equilibrium price volatility, rate of mean reversion, correlation of equilibrium price and spot price, jump rate, jump volatility and mean jump size.

2. The system of claim 1 wherein the historical market data is input into the database manually.

3. The system of claim 1 wherein the historical market data is input into the database automatically when the historical market data is periodically updated.

4. The system of claim 1 wherein the seasonality is determined using an extrapolation process.

5. The system of claim 1 wherein the seasonality is determined using an interpolation process.

6. The system of claim 1 wherein the jump values removed are larger than a predetermined number of standard deviations of the historical market data.

7. The system of claim 6 wherein the predetermined number of standard deviations is between 3 and 5.

8. The system of claim 1 wherein the long-term equilibrium price is estimated to be the mean of the equilibrium price data.

9. The system of claim 8 wherein the mean of the equilibrium price data is found using a linear regression of the equilibrium price data.

10. The system of claim 9 wherein the price growth rate is estimated to be the slope of the linear regression.

11. The system of claim 8 wherein the equilibrium price volatility is estimated to be the average magnitude of noise divergences from the mean.

12. The system of claim 11 wherein the rate of mean reversion is estimated to be the rate at which the price returns to the long term equilibrium price from a noise divergence.

13. The system of claim 1 wherein the correlation of equilibrium price and spot price is estimated by comparing the means of each.

14. The system of claim 1 wherein the jump rate is estimated to be the average time between past jumps, based on a linear regression of the jump values.

15. The system of claim 14 wherein jump volatility is estimated as the amount of variance in the size of jumps.

16. The system of claim 1 wherein the mean jump size is estimated as the average size of all jumps mean of the equilibrium price data.

17. A method for parameter estimation for use in determining value-at-risk, comprising the steps of:
providing a computer program for use with a computer having a memory;
providing a database of historical market data;
the computer program configured to:
process the historical market data to remove seasonality effects;
process the historical market data to identify and remove jump values;
save the removed jump values as a first set of modified market data;
save the historical market data that have been processed to remove seasonality and jump values as a second set of modified market data;
use the first and second set of modified market data to estimate one or more of the parameters selected from the group consisting of long-term equilibrium price, equilibrium price growth rate, equilibrium price volatility, rate of mean reversion, correlation of equilibrium price and spot price, jump rate, jump volatility and mean jump size.

18. The method of claim 17 wherein the historical market data is input into the database manually.

19. The method of claim 17 wherein the historical market data is input into the database automatically when the historical market data is periodically updated.

20. The method of claim 17 wherein the seasonality is determined using an extrapolation process.

21. The method of claim 17 wherein the seasonality is determined using an interpolation process.

22. The method of claim 17 wherein the jump values removed are larger than a predetermined number of standard deviations of the historical market data.

23. The method of claim 22 wherein the predetermined number of standard deviations is between 3 and 5.

24. The method of claim 17 wherein the long-term equilibrium price is estimated to be the mean of the equilibrium price data.

25. The method of claim 24 wherein the mean of the equilibrium price data is found using a linear regression of the equilibrium price data.

26. The method of claim 25 wherein the price growth rate is estimated to be the slope of the linear regression.

27. The method of claim 24 wherein the equilibrium price volatility is estimated to be the average magnitude of noise divergences from the mean.

28. The method of claim 27 wherein the rate of mean reversion is estimated to be the rate at which the price returns to the long term equilibrium price from a noise divergence.

29. The method of claim 17 wherein the correlation of equilibrium price and spot price is estimated by comparing the means of each.

30. The method of claim 17 wherein the jump rate is estimated to be the average time between past jumps, based on a linear regression of the jump values.

31. The method of claim 30 wherein jump volatility is estimated as the amount of variance in the size of jumps.

32. The method of claim 17 wherein the mean jump size is estimated as the average size of all jumps mean of the equilibrium price data.
